(19) United States
(12) Patent Application Publication
(10) Pub. No.: US 2010/0299603 A1
(43) Pub. Date: Nov. 25, 2010

(54) User-Customized Subject-Categorized Website Entertainment Database

(76) Inventor: Bernard Farkas, Herndon, VA (US)

Correspondence Address: HYRA IP, PLC, 11710 Plaza America Drive, Suite 2000, Reston, VA, 20190, US

(21) Appl. No.: 12/785,171

(22) Filed: May 21, 2010

Related U.S. Application Data
(60) Provisional application No. 61/180,708, filed on May 22, 2009.

(51) Int. Cl. G06F 17/30; G06F 3/01

(52) U.S. Cl. 715/733; 707/723; 707/E17.014; 707/769

(57) ABSTRACT

A dynamic website database system constructs, maintains and rank orders a searchable database of media works. Each media work is assigned attributes that relate to subject matter categories, in addition to general entertainment ratings. The system rank orders each media work separately in each applicable category. Users access the website over the Internet and categorize the media works in the database, add new titles to the database, and rank them by category. Users search for media works of interest by category and by rank within the category and rent or purchase media works and related items through the website. Bloggers, discussion forums, and informational links draw individuals passionate about a given subject to the site and cause them to form virtual associations, which are ready made sources for evaluating, financing and developing new media works and marketing and selling existing media works.

This application claims the benefit of U.S. Provisional Applications No. 61/180,708, filed May 22, 2009, which is hereby incorporated by reference in its entirety.

### BACKGROUND

There are about 20,000 associations and societies in the USA alone. All of these affinity groups are based on special interest topics: Architecture, Mathematics, Social Workers, Music, Lawyers, Law Enforcement, Professional Women, etc. These organizations have many thousands of members, ordinary people who like to be entertained and informed. In the aggregate, millions of people from across the country and the world are involved. It is truly a world wide phenomenon, involving tens of millions of people, many of whom are only loosely organized. People join these organizations because they have great interest and passion in niche subjects for a host of reasons. People will read books and watch movies that match up with these subjects, but it's very difficult to find movie and book lists that are categorized with these subjects.

The world market for and interest in books and movies is large and growing. Increasingly, interested persons are turning to the Internet for information about books and movies and to purchase books and movies, either in physical or digital formats. Internet sites such as IMDB.com provide information on movies and Internet retail sites such as Amazon.com sell books and movies. However, there is no resource, online or otherwise, that provides detailed, dynamic information about the specific subject matter content of movies and books or is structured to facilitate and complement the spontaneous organization of groups of people sharing a common subject matter interest.

Needs exist for improved resources for categorizing, rating, displaying, and providing information on movies, books, and other stories by subject matter content and for facilitating and complementing the spontaneous organization of groups of people sharing common subject matter interests.

### SUMMARY

It is to be understood that both the following summary and the detailed description are exemplary and explanatory and are intended to provide further explanation of the invention as claimed. Neither the summary nor the description that follows in intended to define or limit the scope of the invention to the particular features mentioned in the summary or in the description. Rather, the scope of the invention is defined by the appended claims.

In certain embodiments, the disclosed embodiments may include one or more of the features described herein.

It will be understood that where the exemplary embodiments discussed below make references to stories, books, or movies, these are by way of example only. The present system and method is applicable not only to stories, books, and movies, but also other forms of entertainment, art, and information including but not limited to magazine and newspaper articles, seminar and teacher writings, lecture and discussion group reports and minute taking, inventions and patent disclosures, textbooks and instruction manuals, legal briefs and court proceedings, music, software, artwork, computer games and video games, interactive entertainment, and other mass media. In general, intellectual property conveyed in any written, audio, or visual format can be classified in the manner described herein. Collectively, such forms of entertainment, art, and information are referred to herein as “media works.” Media works can be conveyed in a tangible or intangible format, such as, but not limited to: music, written or printed text, magnetic tape, computer generated outputs (DVD, CD, etc) computer to computer transfers, voice and audio transmissions, and performing arts forums.

A media work having a narrative form is referred to herein as a “story”. A work effort, for example combining ideas and thoughts of one or more people with money, labor, and resources, directed towards the creation of a media work, is referred to herein as a “media project.” A “subject matter category” is an identifying term that describes an attribute or feature of a media work. In some embodiments each subject matter category is organized in a family tree arrangement of subject matter categories assigned to media works. A “rank” or “ranking” as used herein, can be a relative ranking or a numerical rating.

A new method of ranking, organizing and displaying media or other information by subject matter category makes it possible to market to and satisfy the needs of niche organizations and loosely organized affinity groups that have strong interests in certain specific and/or obscure categories, and other associations or persons with such interests. The method utilizes a website that uses a threaded database to store movie and book entries. The website provides a new and different way to classify books and movie stories and classifies them to a level of detail not used before. The design allows for easy expansion to add an unbounded number of categories.

The website is targeted specifically at niche interest groups/organizations/associations and loosely organized or informal collections of people that fall under the definition of an affinity group. For example, an amputee association may search for movies with subject matter relating to amputation or amputees, a historical association may search for movies and/or books relating to a specific historical time period, etc.

The website includes a new dynamic database system that constructs, maintains, and rank orders a searchable database of fiction and non-fiction stories that exist in photoplay (video) and text (download books, etc.) formats, where each story is assigned a set of multiple attributes, as appropriate, that relate to subject matter categories. Users access the website over the Internet and are able to categorize the movies and books in the database, add new titles to the database, and rank them by category. Users search for and display movies and/or books of interest by category and by rank within the category and are given the option of renting or purchasing movies and books through the website.

The site thus acts as an efficient niche marketing, or narrowcasting, website, providing specialized products to groups and individuals with a very specific interest. Other items related to the movies, books, and other stories or to the subject matter they contain are also sold through the website, for example the stories and scripts behind movies. Additional items can include subject matter training aids and educational opportunities, subject matter text books, subject matter products and services, network access to subject matter consultants and authorities, volunteer labor, subject matter laws and governmental entitlements, display devices for famous subject matter quotations, and subject matter contract offerings and business opportunities, network access to other subject matter enthusiasts for developing, improving, financing and investing in other subject matter stories, and more. A set of financial products for raising money to start or complete new book or photoplay projects would be of great interest to many people and is also sold through the site, for example, prospectus and due diligence documents, subscription documents, blue sky registrations, etc.

Individuals with a passion for a certain subject are attracted to the site and encouraged to continue to return to and use the site by providing additional subject matter information, such as discussion forums and links to other relevant informational websites, related products and services as described above, volunteer labor in the form of writers, actors, and production workers, and by acting as a clearing house and opportunity site for creating, financing, developing, and distributing other stories (videos and books) on the subject matter. Dynamic sources of new content and information about different subjects are utilized, such as bloggers discussing relevant topics.

This website draws together people sharing a common interest and encourages them to form virtual associations. These associations of people with shared interests will come together and have a desire to invest in certain projects promoting their interests. The website takes advantage of the virtual associations formed to market to associations and draw on them as a source of funding for the creation of new stories of interest to the associations. The website acts as a clearing house for developing, financing and distributing new products, aspects of which are built into the back end Admin Page.

The website is used as a resource for media producers to reach out and determine what kind of stories interest groups are interested in, what kind of documentaries, books, etc. they want to see made. People interested in producing such works then partner with the association and/or affinity group to produce a story with a ready-made audience and market. Alternatively, Hollywood producers and book publishers are charged a fee to participate on the site and hold on-line focus groups for new niche subject matter stories accessing this network of users. The site audience is also used for commenting on video rough cuts and book first drafts and for commenting on story treatments. Access to this type of resource is a very valuable commodity and no other ready source for this type of service now exists.

These and further and other objects and features of the invention are apparent in the disclosure, which includes the above and ongoing written specification, with the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 is an example screen shot showing a website implementation of user ranking of stories within categories.

FIG. 2 is an example screen shot showing a website implementation of user addition of a new story within an existing category.

FIG. 3 is an example screen shot showing a website implementation of user addition of a new subject matter category.

FIG. 4 is an example screen shot showing a website implementation of navigation of link topics related to a subject matter category within a category tree.

FIG. 5 is an example screen shot showing a website implementation of a display of category links within a given topic related to a subject matter category.

FIG. 6 is an example screen shot showing a website implementation of a top-level display presenting user options.

FIG. 7 is an example screen shot showing a website implementation of display and navigation of sub-categories within subject matter categories.

FIG. 8 is a flowchart diagram showing the navigation of an example website implementation.

FIG. 9 is an example screen shot showing another website implementation of user ranking of stories within categories.

FIG. 10 is an example screen shot showing a website implementation intermediary category tree page.

FIG. 11 is an example screen shot showing a website implementation contact page.

FIG. 12 is another example screen shot showing a website implementation top-level display presenting user options.

FIG. 13 is an example screen shot showing a website implementation movie details page. FIG. 14 is an example screen shot showing a website implementation view ratings pop-up.

FIG. 15 is an example screen shot showing a website implementation pop-up for adding comments on a movie.

FIG. 16 is an example screen shot showing a website implementation of a user login.

FIG. 17 is an example screen shot showing a a website implementation top-level display presenting user options.

FIG. 18 is an example screen shot showing a website implementation search movie titles page.

FIG. 19 is an example screen shot showing a website implementation of a search for movies by category page.

FIG. 20 is an example screen shot showing a website implementation of nonfiction works related to a subject matter category.

### DETAILED DESCRIPTION

A user-customized, subject-categorized website entertainment database will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail.

It will be understood that the particular website layouts shown in the screenshots below are exemplary only. The positioning of the various items can be altered as desired, and some items and functions may be added, deleted or altered within the spirit and scope of the present invention, as defined in the appended claims.

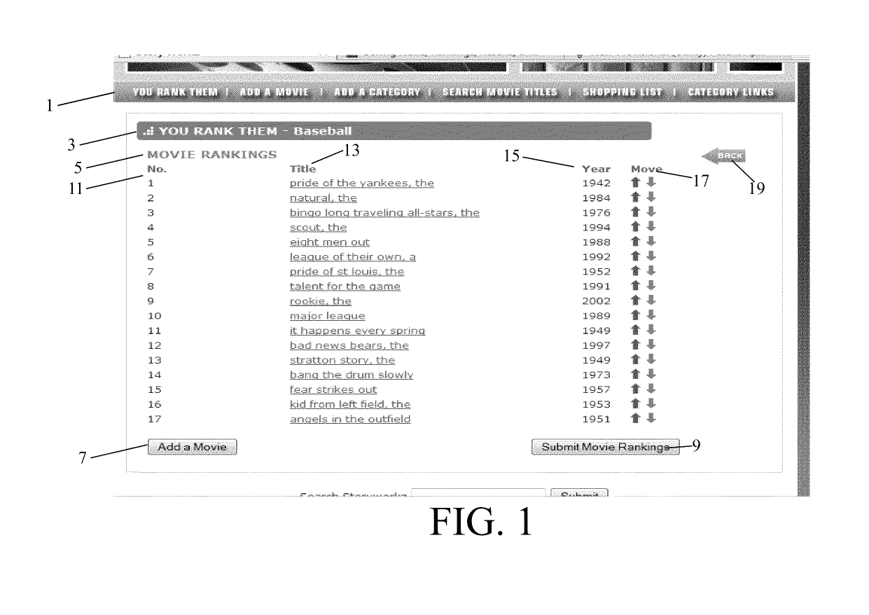

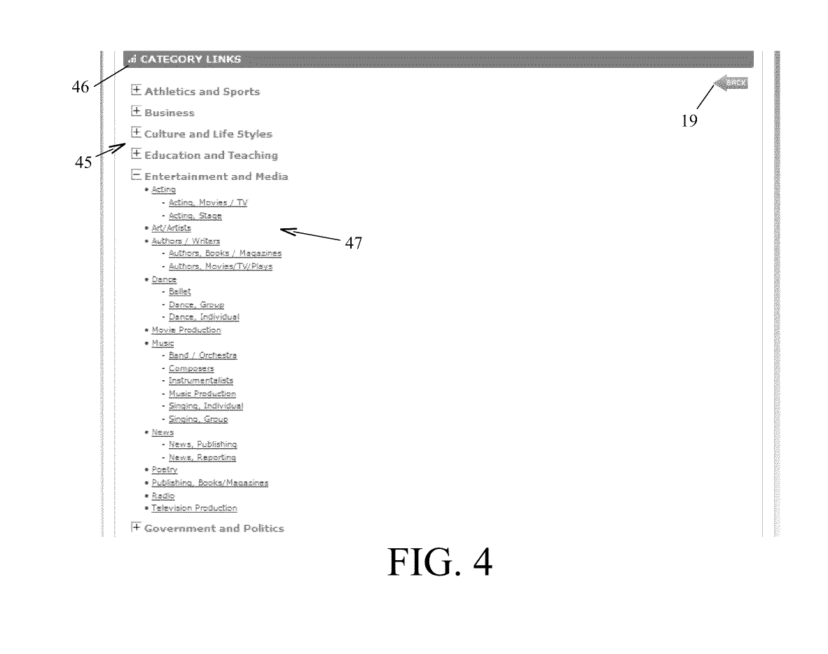

FIG. 1 is an example screen shot showing a website implementation of user ranking of stories within categories. Everybody has a different value system and users are encouraged to provide their opinions so that their inputs can be measured. First, a user clicks through to the lowest level on the category tree to retrieve the correct current movie rankings 5. (The category tree is discussed in detail further below in conjunction with FIGS. 4, 7, and 10, and elsewhere in this document.) In the embodiment shown, there is a page description bar 3 showing that the current page is for user ranking and also showing the selected category, which in this screenshot is baseball. The rankings consist of the rank number 11, the title 13 of the movie with that rank, and the year 15 the movie was released.

Then, the user follows the prompts 17 to re-arrange the rank order of the movies. The new order is submitted using the submit movie rankings button 9 and incorporated through the use of an algorithm into the existing movie rankings A person of skill in the art will recognize that this ranking adjustment could be performed in a variety of ways, for example with numerical or otherwise scaled ratings. A movie is also added to the selected category from this screen by selecting the add a movie button 7. The back button 19 allows a user to return to the previous step of selecting the appropriate category. Navigation bar 1 allows a user to navigate to a variety of website pages from any other page without intermediate steps.

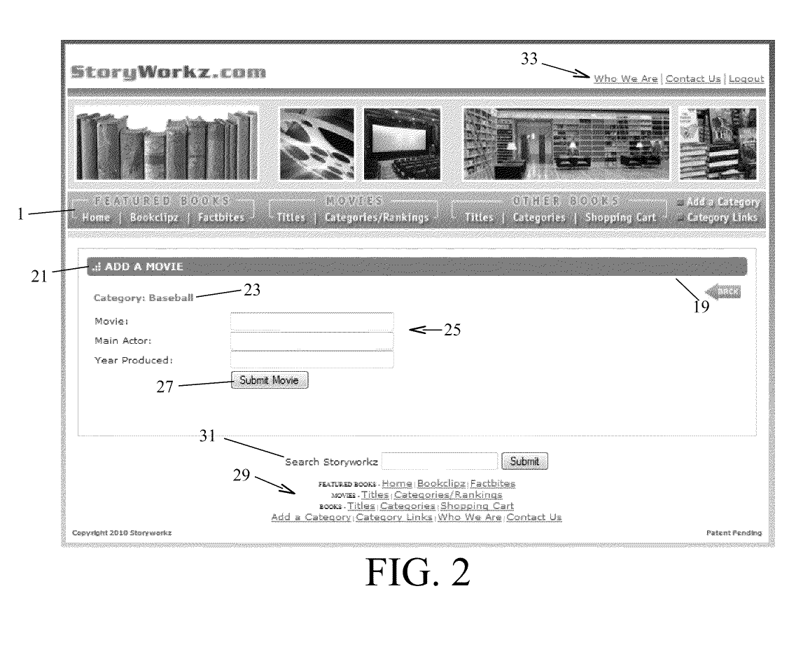

FIG. 2 is an example screen shot showing a website implementation of user addition of a new story within an existing category, an Add a Movie page. Here a user adds other movies to the rankings First, the user clicks through to the lowest level on the category tree so that the movie suggestion can be placed in the correct spot. (The category tree is discussed in detail further below in conjunction with FIGS. 4, 7, and 10, and elsewhere in this document.) Then, the user follows the prompts to enter the new movie information and submit it to the database. Page description bar 21 shows that this is the add a movie page. Category display 23 shows that in this screenshot the selected category is baseball. In this embodiment there are fields 25 for the details of the new movie title, main actor, and year produced. These new movie details are submitted by pressing the submit movie button 27. Also shown in this screenshot are top and bottom intra-site links 33, 29 respectively, which allow a user to navigate directly to certain pages of the site from any other page. Search bar 31 allows a user to search the entire site for a given character string.

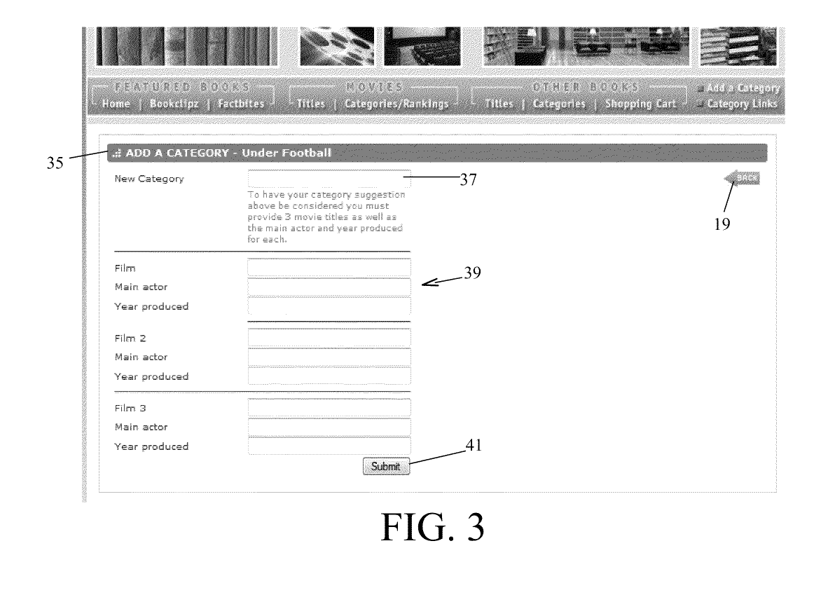

FIG. 3 is an example screen shot showing a website implementation of user addition of a new subject matter category, an Add a Category page. Books and movies are filled with stories about people placed in different situations, with different themes or subjects; e.g., Korean war, chemistry, baseball, banking, etc. An initial categorization in one embodiment includes subjects whose content is included in five, or more, quality movies. Users then have the chance to propose additional subjects to the category tree. (The category tree is discussed in detail further below in conjunction with FIGS. 4, 7, and 10, and elsewhere in this document.) To give the rankings a push, the user is requested to list three, or more, quality movies covering that subject.

First, the user reviews the existing category tree to determine if the user wants to start a new branch, or add to an existing tree limb. Then, prompts are followed to enter a proposed new subject category and its movie information and submit it to the database. In this embodiment, the page description bar 35 indicates that this page is for adding a category and shows that the category will be added to the existing category of athletics and sports. There is a field 37 for the name of the new category and fields 39 for details (name, main actor, year produced) of three movies to be included in the category. The field entries are submitted using the submit button 41.

FIG. 4 is an example screen shot showing a website implementation of navigation of link topics related to a subject matter category within a category tree. In this embodiment, the page description bar 46 shows that the page is a category tree for category links. On this page, there are a number of top-level categories 45 and one of these categories has been selected and expanded by clicking on it, revealing its sub-categories 47.

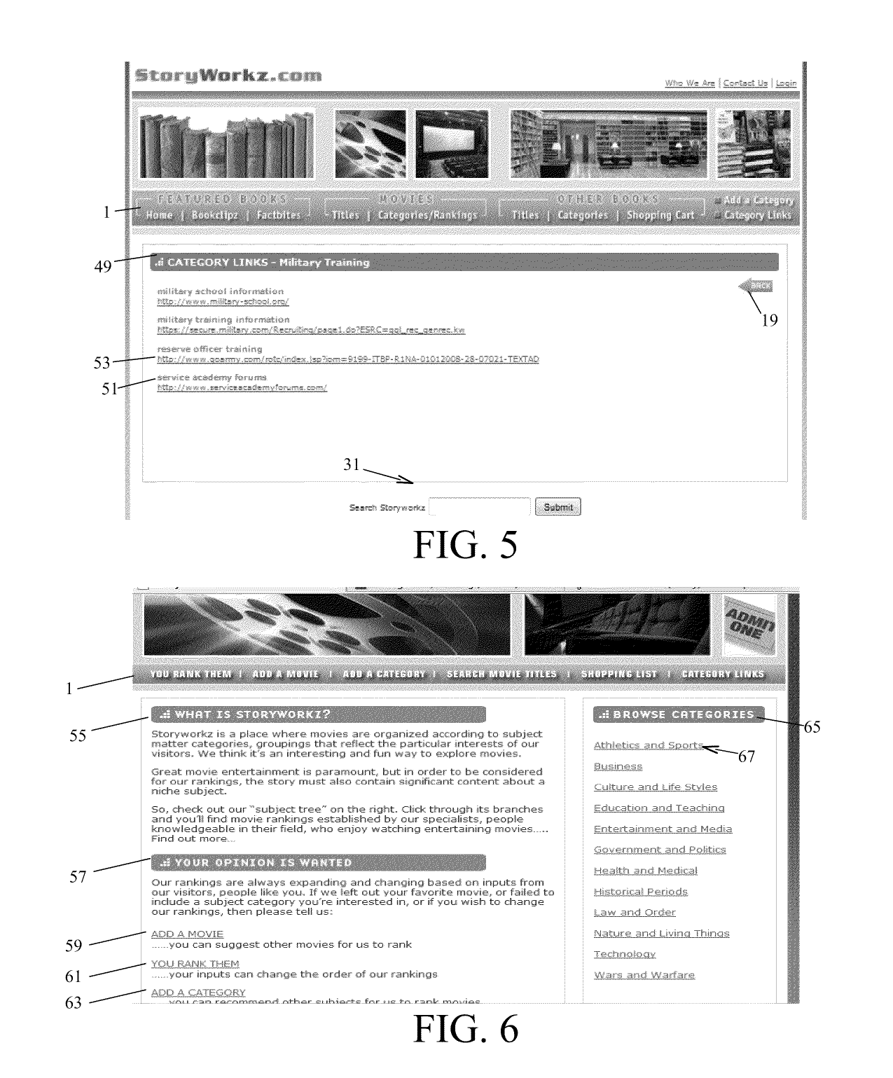

FIG. 5 is an example screen shot showing a website implementation of a display of category links within a given topic related to a subject matter category. In this embodiment, the page description bar 49 shows that the military training sub-category has been selected and that category links are displayed. Here there are a number of website links 53 with descriptions 51.

Appropriate links are provided to those affinity groups (associations, organizations, and clubs) whose interests match up with the subject matter categories. Visiting them allows a user to grow his or her knowledge about a field. Information computer links are established with subject matter specialists to increase the enjoyment, knowledge and education of the user population.

The website liaisons with, organizes, provides, and maintains a variety of two-way private and public on- line data links to existing and established subject matter category affinity group networks that add to the knowledge base, entertainment value, or business of all website users.

FIG. 6 is an example screen shot showing a website implementation of a top-level display presenting user options. On the right in this embodiment is a “subject tree” 67. A user clicks through its branches to find movie rankings by category. The browse categories button 65 above it, when clicked, displays a full subject tree on its own page for navigation (as shown, for example, in FIG. 4 above). On the left is a description of the site and an explanation of how to use it 55. Below that is a user-interactive section 57 detailing interactive features of the site.

This section includes central buttons 59, 61, 63. The rankings are always expanding and changing based on inputs from users. If a user's favorite movie has been left out, or a subject category the user is interested in has not been included, or if the user wishes to change the rankings, he or she can remedy the situation by navigating through the central buttons. In this embodiment, the first button 59 is for suggesting another movie to be added to the rankings The second button 61 is for the user to provide his or her own inputs to change the order of the rankings The third button 63 is to recommend another subject category in which to rank movies. As with the other screenshots, this layout is merely exemplary and the positioning of the various items can be altered as desired.

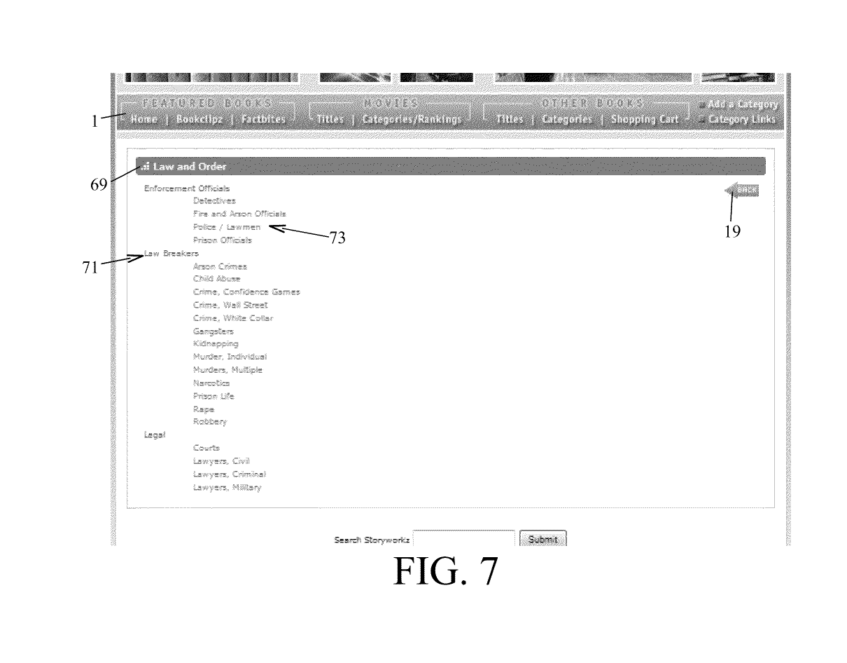

FIG. 7 is an example screen shot showing a website implementation of display and navigation of sub-categories within subject matter categories. In this screenshot, the top-level category of Law & Order has been selected, as shown on the page description bar 69. Below, the sub-categories 71 are broken out and indented beneath them, the sub-sub-categories 73 that fall within each sub-category 71.

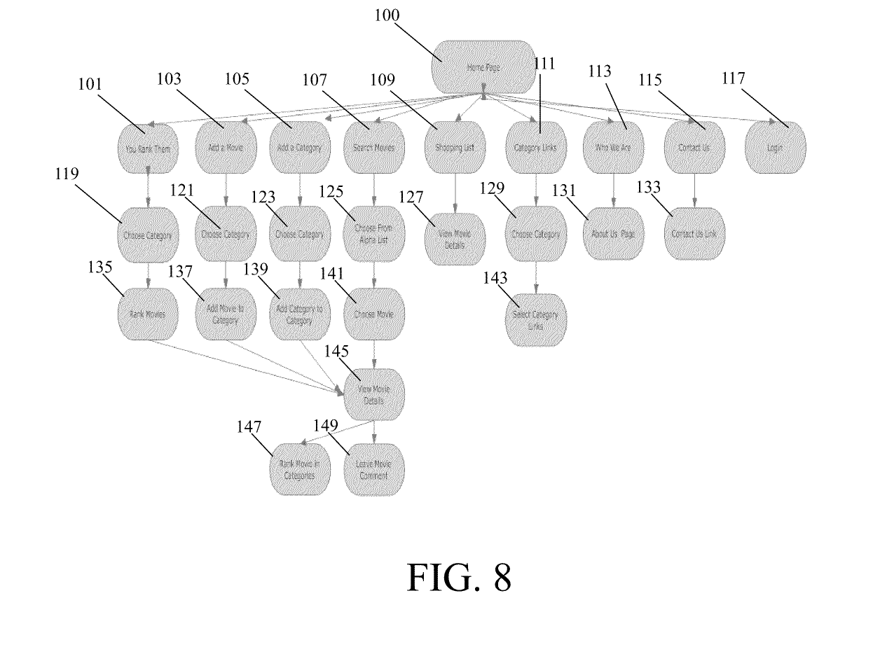

FIG. 8 is a flowchart diagram showing the navigation of an example website implementation. At the top level is the home page 100, an example of which is illustrated in FIG. 6. From there, a user can navigate to any of the next-level pages, including the main You Rank Them page 101, Add A Movie page 103, Add a Category page 105, Search Movies page 107, Shopping List page 109, Category Links page 111, Who We Are page 113, Contact Us page 115, and Login page 117.

A user has unlimited access to all of the information in the database without performing the Login function. Any time the user wishes to insert data into the website; to add a title, enter a ranking/rating, buy something, send an email, etc., a Log In in some embodiments is required. The IP number of each computer is identified when a user goes through the Ranking Process. This prevents the same computer from skewing the results with a multitude of ranking votes. In one embodiment, user category preferences are tracked from the IP number or from the Email address of the Log-in, creating a narrow casting capability for future product sales, marketing, financing and focus groups.

In one embodiment, user comments, email comments, website navigation patterns, survey responses, new category requests, new book requests, ratings and product orders are collected and retained by the website in association with each user's specific identification information (alias name, real name, mailing address, phone numbers, email address, etc). The website enables search and analysis software, similar to what Google Analytics provides, to mine this database to extract useful and important demographic information for enhancing and promulgating future intellectual property developments and furthering new and expanded intellectual property business opportunities, creating and selling new media works. In this regard a standard Administrative Panel section for keeping rudimentary track of each user is in one embodiment expanded into an enhanced user repository for every piece of user action.

After selecting the You Rank Them page 101, a user selects a category 119 and then navigate to the movie ranking page for that category 135 as illustrated by FIG. 1. After selecting the Add a Movie page 103, a user selects a category 121 and then adds a movie to that category 137 as illustrated by FIG. 2. After selecting the Add a Category page 105, the user selects a category 123 and then adds a category to the added category 139. After selecting the Search Movies page, a user navigates an alphabetical list 125 and then chooses a movie 141.

From the movie ranking page 135, add movie to category page 137, add category to category page 139, or choose movie page 141, the user views the details of a movie 145, for example by clicking on the movie title. The data base sheet (movie details page) for the title then appears. The user rates the title in the categories 147 assigned to it on that page or add his or her personal script comments about the title 149. Each category assigned to the title can be rated. Only movies ranked by the subject matter category tree are shown.

The comments are intended for public Web publication. Therefore, in an embodiment, the system has a back end editing function, accessible not to general users but rather to system administrators or similar system supervisors or editors, to make sure the messages are reviewed and if necessary cleaned up prior to Web publication. (The back end editing feature is not illustrated.)

After selecting the Shopping List 109, a user views the details of a movie listed 127. In an alternative embodiment, the Shopping List 109 is replaced with a Purchase Function. The Purchase Function allows a user to purchase a movie or book from a movie details page, for example with a direct link to a purchase Web site such as Amazon.com. For executing a purchasing function all of the movie and book icons displayed on the site are linked to a multitude of different vendor sites, including one incorporated into the Storyworkz website. After selecting the Category Links page 111, a user selects a category 129 and then selects category links 143 within that category. After selecting the Who We Are page 113, a user can navigate to the About Us page 131.

After selecting the Contact Us page 115, a user selects a contact us link 133 to contact the site administrator. The administrator of the site is the contact point for the site, not a customer service person. The space on the page to enter script passages is used for making any suggestions, comments or criticisms on the information content of the title or purpose of the site. Also, this space is used to communicate with people who wish to become subject matter specialists who can act as host moderators for different subject category areas.

This script space is also used to receive unsolicited story ideas for new movies and books, for funding requests for finishing partially completed projects, and for processing distribution opportunities for other niche products. In another embodiment, menu templates are used to accomplish some of these functions in a more organized and user friendly manner. The text entered in the script space goes to the site administrator by Email messages or similar electronic messaging, and is received and processed by people in a back office.

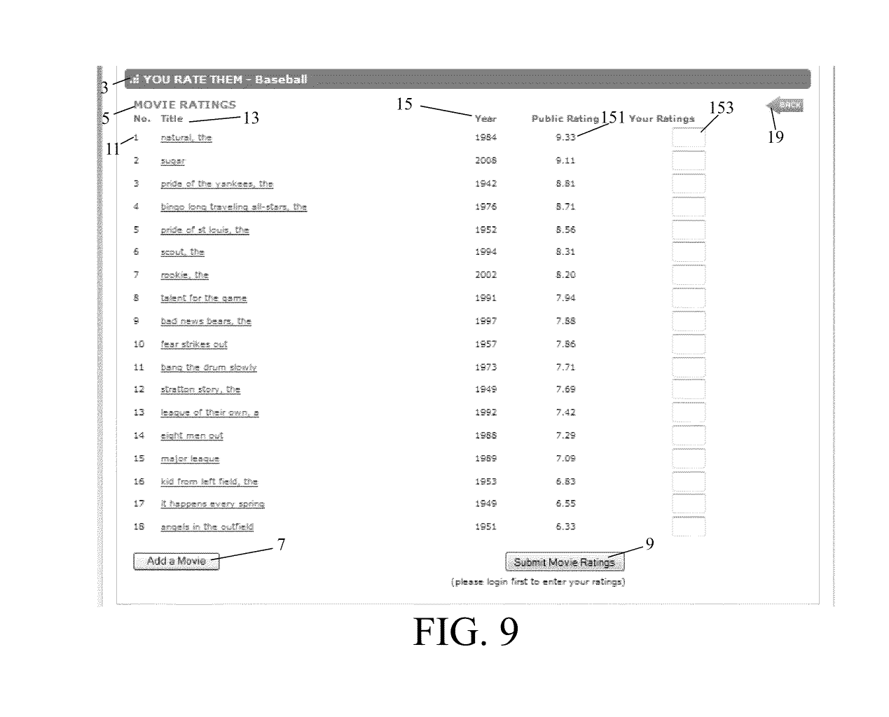

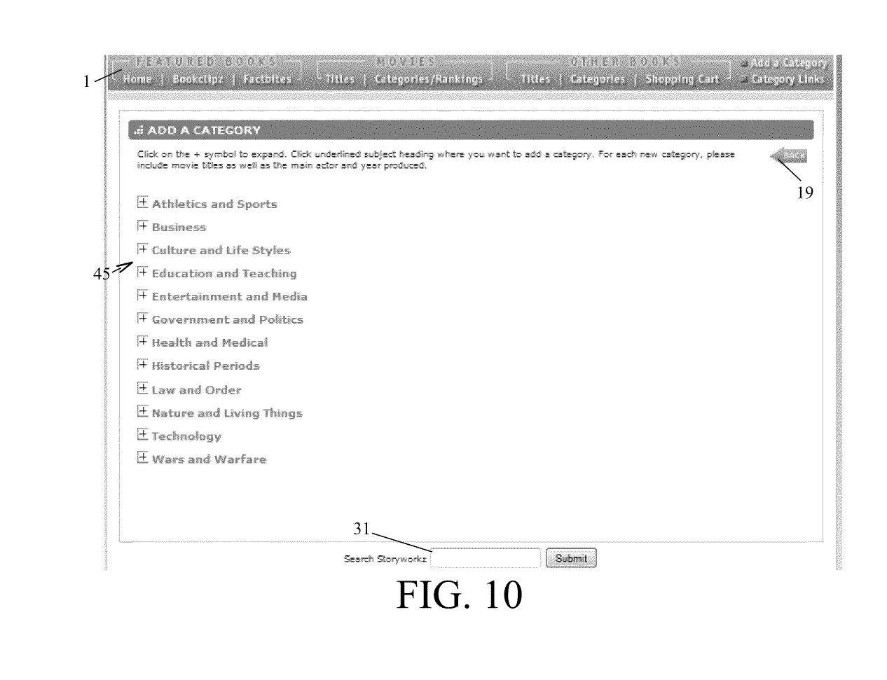

FIG. 9 is an example screen shot showing another website implementation of user ranking of stories within categories. Here, as in FIG. 1, all the titles 13 within a category and their rank numbers 11 and year 15 are shown, along with buttons for adding a movie 7 or submitting ratings 9. However, in this implementation there is a numerical ranking 151 for each movie. Each movie has a space 153 for a user to enter his or her own ratings. A user enters ratings for any number of movies in the category from this page. The user's ratings are averaged with the existing ratings and a new public rating is calculated. In one embodiment, the user must be logged in to enter ratings in order to prevent spam ratings. In that embodiment, the logged-in user's ratings are associated with that user, so the user's ratings are tracked and the user can change his or her rating for any movie at any time. Additional mechanisms may also be employed to prevent spam ratings, for example a challenge-response test, which may be custom designed for the present application or may be implemented using third-party Captcha systems.

FIG. 10 is an example screen shot showing a website implementation intermediary category tree page. When a user chooses to add a movie or add a category, a page appears with a list of top-level categories 45 so that the user can choose a category in which to add a movie or new sub-category.

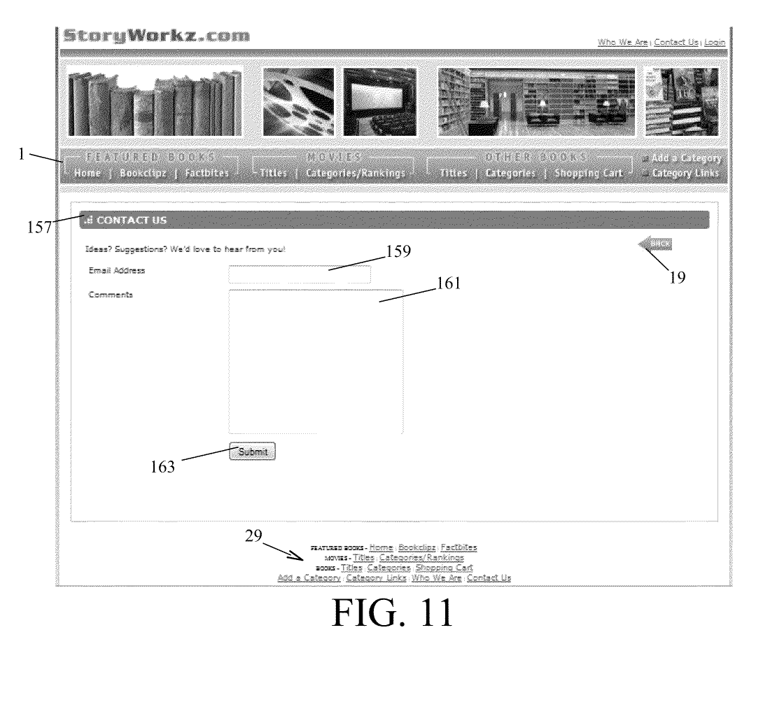

FIG. 11 is an example screen shot showing a website implementation Contact Us page. The page description bar 157 shows that this form is for contacting the site management. Here a user fills in an email address box 159 and comment box 161 and submits this information to the site management with submit button 163. On the back-end, site administration side, this information is made to be forwarded in an email or other communications method to any person desired. In this way, users can securely transmit comments on the website, suggestions, or even ideas for new documentaries, etc.

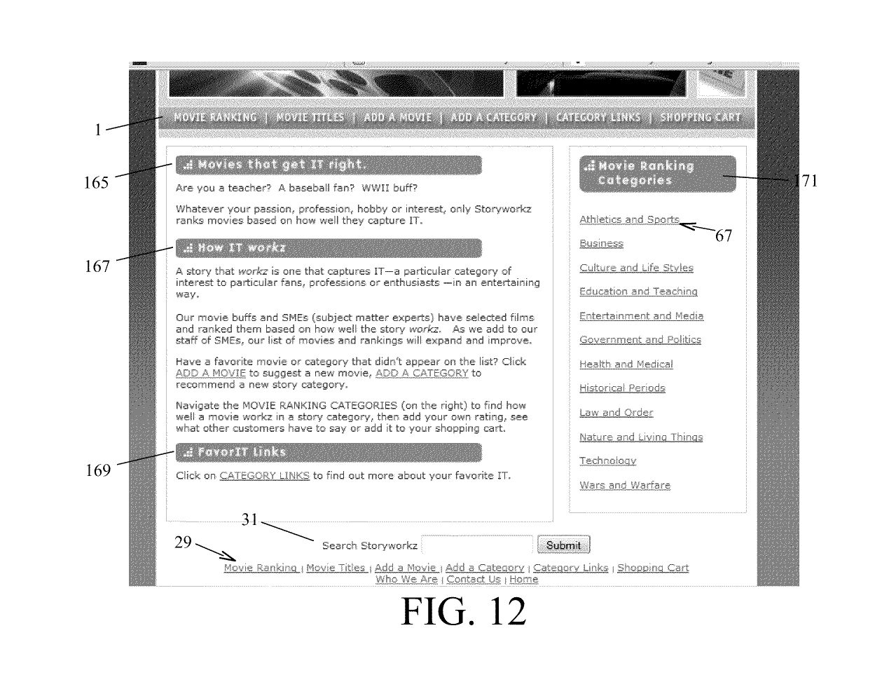

FIG. 12 is another example screen shot showing a website implementation top-level display presenting user options. In this implementation there are three sections on the left side of the page: an introductory section 165 laying out the site concept, explanatory section 167 explaining how the site is run, the site contents, and how the user can interact with the site and giving links for adding new movies and categories, and link section 169 introducing the category links. On the right side is a movie ranking categories section 171 with a subject tree 67.

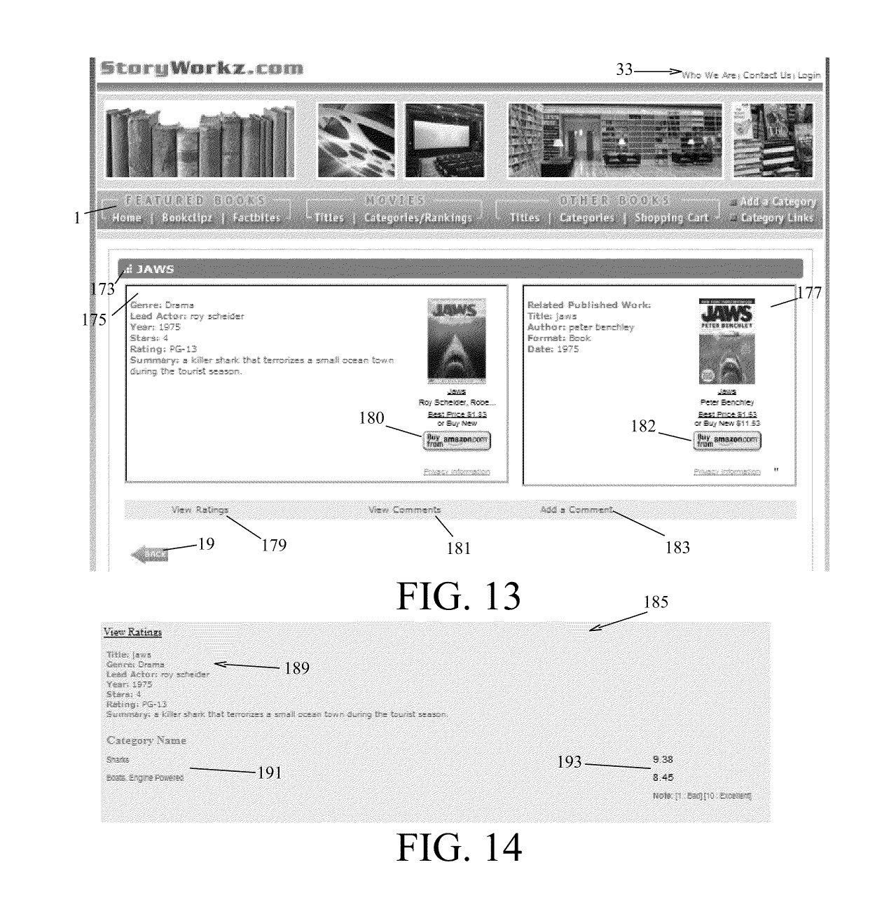

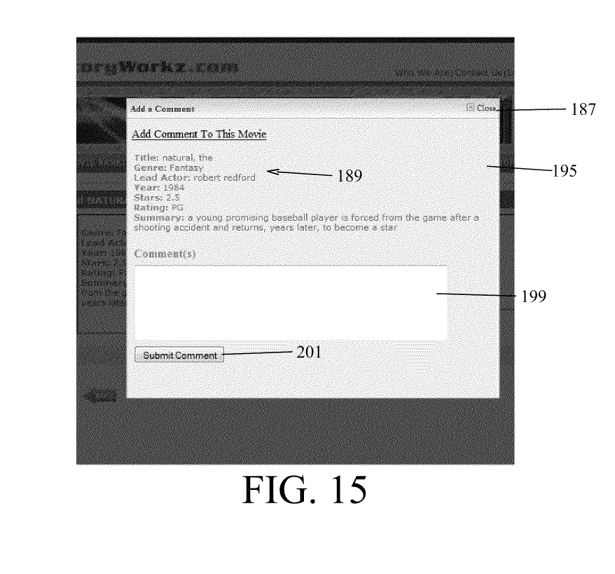

FIG. 13 is an example screen shot showing a website implementation movie details page. This page is arrived at, for example, by clicking on a movie title wherever movie titles are shown, for example on the ratings page in FIGS. 1 and 9. This page shows the movie title 173 and has a details box 175 that contains facts about the movie, for example genre, lead actor, year, stars, rating, and plot summary. There is also a graphic link 180 for purchasing the movie (in some embodiments in various formats, such as DVD, Blu Ray. etc.). Related published work box 177 shows the details of any related books or other works and also has a graphic link 182 for purchase of the related work. In this example, a related book is shown with title, author, format, and date. View ratings button 179 when selected shows the rating of the movie in different categories, for example in the pop-up box as shown in FIG. 14. Add a comment button 183 allows a user to add comments about the movie, for example using the pop-up box as shown in FIG. 15. The view comments button 181 allows a user to view comments added by users.

FIG. 14 is an example screen shot showing a website implementation view ratings pop-up 185. Details 189 are again shown as in the movie details page. The categories in which the movie is rated are displayed 191 and the rating for each category 193 is displayed. Close button 187 closes the pop-up.

FIG. 15 is an example screen shot showing a website implementation pop-up 195 for adding comments on a movie. Again the movie details 189 are shown, but here there is a comment box 199 for a user to enter comments and a submit comment button 201 for the user to submit them.

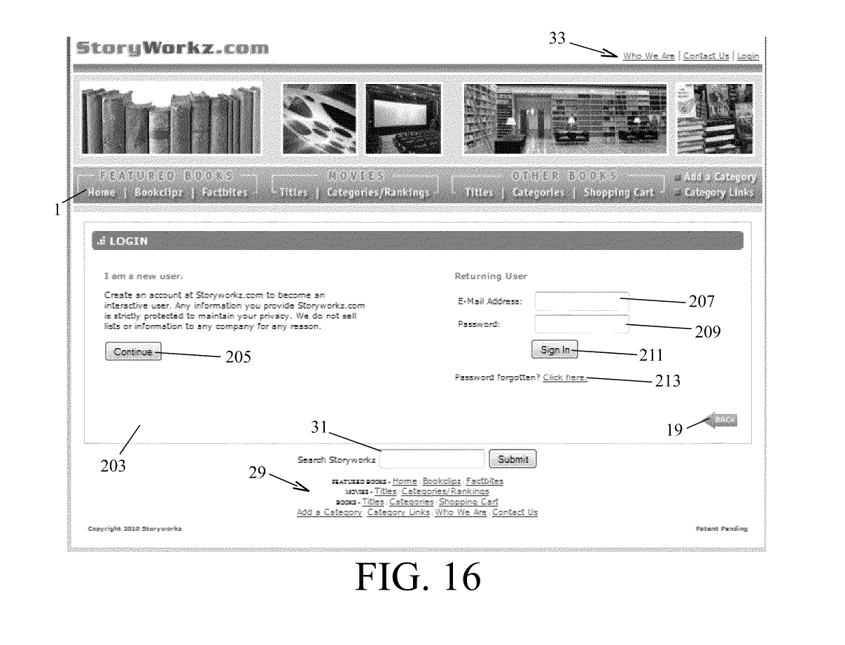

FIG. 16 is an example screen shot showing a website implementation of a user login. On this page is the login box 203 where new users click the continue button 205 to register and login for the first time. Returning users enter their information in the email address input box 207 and password input box 209 and sign in by pressing the sign in button 211, or press the forgotten password link 213 to retrieve their password.

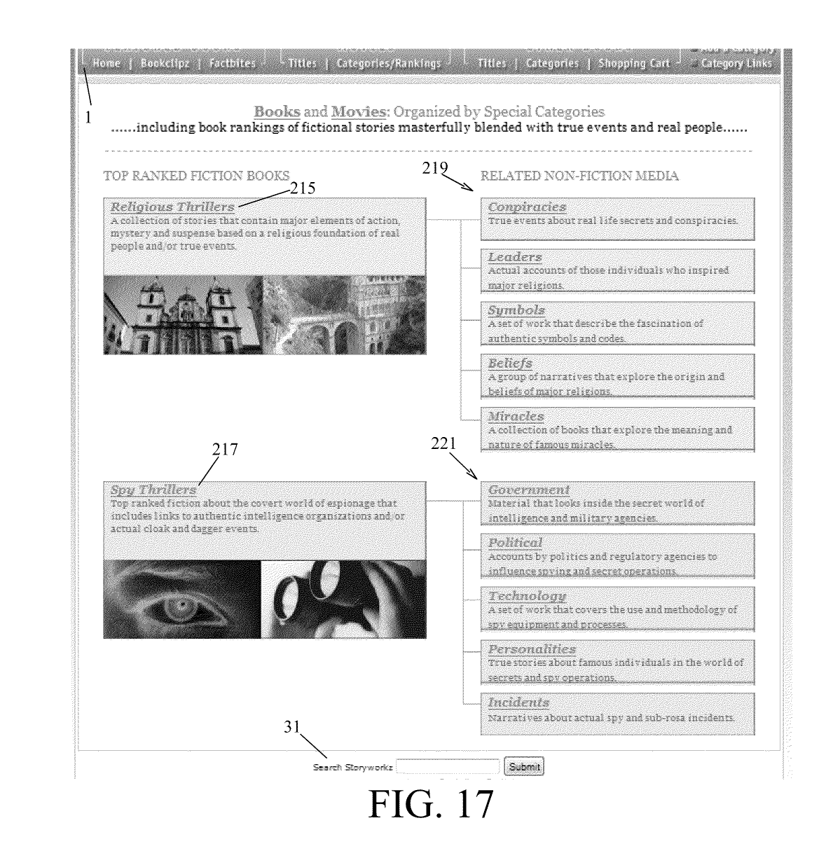

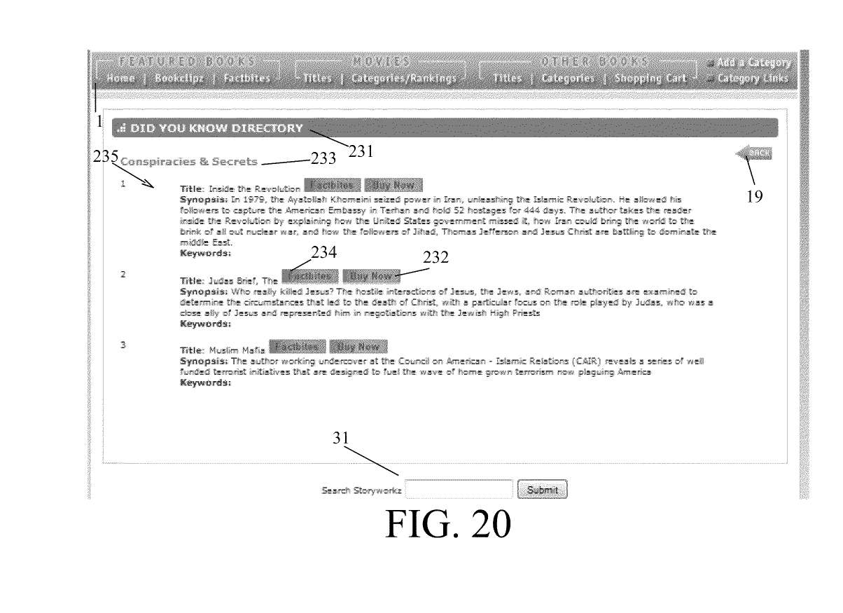

FIG. 17 is an example screen shot showing a a website implementation top-level display presenting user options. On this page, featured book categories 215, 217 are highlighted and may be rotated periodically. Selecting the featured categories leads to a category page for the selected category as shown for example in FIG. 9. Associated subject matter categories 219, 221 are displayed, and selecting one of these categories leads to some nonfiction works related to that category as shown in FIG. 20.

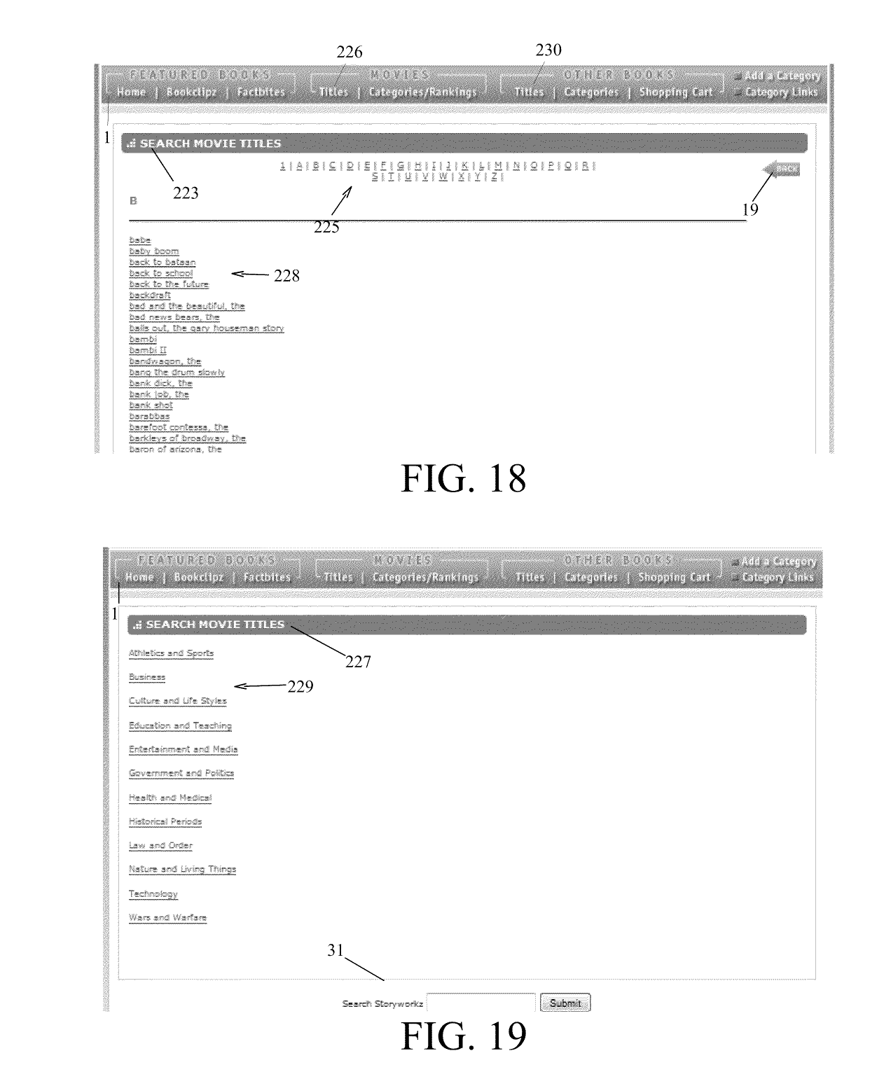

FIG. 18 is an example screen shot showing a website implementation search movie titles page arrived at when “Titles” 226 is selected from the navigation bar 1. The page description bar 223 shows that this is the Search Movie Titles page. Letter links 225 are displayed and selecting them leads to an alphabetical listing 228 of movies from which individual movies can be selected to display their details. A comparable page for books is arrived at by selecting “Titles” 230 under books.

FIG. 19 is an example screen shot showing a website implementation of a search for movies by category page showing top level categories 229 which can be selected and drilled down into subcategories by selecting and page description bar 227.

FIG. 20 is an example screen shot showing a website implementation of nonfiction works related to a subject matter category. Page description bar 231 shows that this is a Did You know Directory page. The subject matter category 233 is displayed along with nonfiction works 235 related to the subject matter category. Buy Now button 232 allows a user to purchase the work through the website, while Factbites button 234 displays facts or quotes selected from the work.

In one embodiment of a new interactive website system, movies are organized according to subject matter categories, groupings that reflect the particular interests of visitors. It's an interesting and fun way to explore movies. The new system constructs, maintains, and rank orders a searchable database of fiction and non-fiction stories that exist in photoplay (video) and text (for book downloads, audio downloads, hard copy deliveries, etc.) formats, that can be loaned, purchased or rented, where each story is assigned a set of multiple attributes that relate to professional, business, medical, consumer, hobby, and other criteria.

### Ranking

A new method of ranking, organizing and displaying media or other information and/or materials, such as movies and books, educational institutions and training aids, software packages, famous subject matter quotations, other websites, and documentaries and how-to videos/books, by category makes it possible to market to and satisfy the needs of niche organizations and unorganized groups of people who have niche market interests, which may have strong interests in certain specific and/or obscure categories, and other associations or persons with such interests. A person of skill in the art will recognize that these exemplary types of information and/or materials are not limiting and that many other materials/information could be ranked in a similar manner.

Each piece of media or other information may fall into multiple categories and have separate rankings in each category. The site allows for the ranking of a story according to all its major category descriptors. For example a story title may get a 10 ranking for Chemistry, a 5 ranking for Finance, a 7 ranking for Medical Inventions, and a 3 ranking for White Collar Crime. In some embodiments this does not change the overall entertainment rating of the title for the general market place, for example if it's rated with 3 stars.

The site and contents thereof, including the media or other information ranked, are in some embodiments in a non-English language or in English and another language, and in some such embodiments are translated. The USA alone has 17 million people who speak Spanish as their sole language. These people watch movies and read books.

In one embodiment, a system and method allows users to create categories and to designate which categories a piece of media or other information falls into, and to rank each piece of media/information in each category. The users are allowed to search for and display media/information by category in ranked order to select a piece of media/information appropriate to an interest. The user population determines the rank order of the stories through remote voting methods. Initial categorization and ranking of book/movie entries is based on the input of a few “seed” individuals, with the rankings and entries changing from their initial states according to an algorithm based on the input of later users.

In one embodiment, initially, before ranking votes are accepted from the public pool of general users, the category rankings are set by organizers from inputs made by a small number of hand picked people, approximately three to ten, who are expert in the subject category, through special invitations. The special invitation rankings are computed by making a simple arithmetic average of the three to ten special invitation users. Then, when rankings start coming from the public they are added to the starting base of votes compiled by the special invitation votes and the displayed result is adjusted by the computer using a simple arithmetic average of all ranking votes that have been received. Many other algorithms and variations can be used alternatively within the scope of the invention.

One way of implementing the above example ranking algorithm on a website is to have a back end administrator ranking page where the administrator can place a number between 10 and 100 for each title. This number in one embodiment represents the sum of the rankings of the ten initial hand picked people. This number is not directly visible to the end user.

The user enters their own 1 through 10 number rankings for titles in a template on the site. This number is displayed on the user ranking page and title data sheet when the user is logged in and can be changed by the user at any time from either place. The site identifies each user/voter by their email address, login name, IP number, and/or other electronic or digital signatures (for example, biometric signatures). In one embodiment after a given period of inactivity the site deactivates a user's votes. The site adds the ranking numbers entered by users to the ranking number entered by the administrator and divides by a number which equals ten plus the number of user votes entered.

For example, the administrator enters the number 80, and user/voter A makes a 7 vote and user/voter B makes a 5 vote, then the composite answer is (80+7+5)/12=7.67. The site then re-orders the ranking list shown on the category ranking page with the higher composite numbers placed ahead of the smaller composite numbers. The composite numbers for each title are displayed for the users.

In an alternative embodiment, initial rankings (that is, rankings prior to user votes) may be based on other methods. For example, initial rankings may be obtained from a general, established entertainment database of movie rankings for all movies. For any given movie, the movie would receive a same numerical rating across all categories, and relative rankings between movies would be based on the pre-existing entertainment database rating information. As users begin to add their special category votes, the ratings for a movie would start to vary for different categories for that movie, as well as changing between different movies.

In other words, an established movie like “Gone With The Wind” will now have a multiple set of ratings, a “four star” entertainment movie from existing ratings (that would probably never change because its based on 50 years of surveying)and now also for example a 9.5 for the “civil war”, a 3.7 for “farming and agriculture” and a 6.3 for “parenting”.

In one embodiment, all of these numbers are blended together to present a different entertainment rating for each niche market viewer. The blending is accomplished in a variety of ways in different such embodiments and in some embodiments the method of blending learns over time from user rankings Depending on the blending method, to a civil war buff the entertainment value may now be 3.9 stars, to a farmer it might be only rated at 3.1 stars, and to a parent it may be 3.6 stars.

In an alternative embodiment, different algorithms may be employed to arrive at a ranking for a film based on user votes. For example, in an embodiment, some user votes may be weighted more heavily than other user votes. For example, users known to be associated with certain professional societies, or to have credentials in certain fields, may be assigned more weight in categories associated with those fields. For example, doctors and nurses might be assigned a greater weighting in rankings of movies or books associated with the medical profession (with respect to medical category rankings). Similarly, members of the Armed Forces might be assigned a greater weighting in rankings associated with movies or books pertaining to military matters (with respect to military category rankings). In this embodiment, a Web interface would provide users with the option of providing data pertaining to their professional associations, academic associations, and/or similar personal/professional associations or experience which would affect the weighting of their ratings.

The voting patterns of the user/voter are used for purposes of measuring the demographic interests of the user, identified by email address, login name, IP number or other electronic signature, for other product and marketing initiatives.

### Rating Example

In one example rating method, movie ratings are initially set on the back end of a website. An administrator of the website goes to a back end Rank Movie [Category] Page and enters rating numbers in the boxes provided for each movie. A “weighting number” is additionally entered, which relates to the number of artificial voters entered.

For Example:

The following numbers are entered into the respective boxes as described above:
Movie A=90
Movie B=65
Movie C=77
Weight Number=10

This has the following effect:
Movie A has 10 people ranking that movie with a 9.00
Movie B has 10 people ranking that movie with a 6.50
Movie C has 10 people ranking that movie with a 7.70

The computer then rank orders the normalized vote in the Front End Category Ranking Page, highest number first
1. Movie A 9.00
2. Movie C 7.70
3. Movie B 6.50

The following is the adjusted calculation performed as visitors start voting:
Movie A=90+1+1+2+6+4+5=109/16 votes (10 initial back-end plus 6 visitors)=6.81
Movie B=65+9=74/11 votes=6.73
Movie C=77+9+9+10+6+10=121/15 votes=8.07

The computer then re-orders the Front End Category Ranking Page and displays the normalized vote
Movie C 8.07
Movie A 6.81
Movie B 6.73

One embodiment is a website that uses a threaded database to store movie and book entries. The website provides a new and different way to classify books and movie stories and classifies them to a level of detail not used before. Users access the website over the Internet and categorize the movies and books in the database and rank them by category. Users search for and display movies and/or books of interest by category and by rank within the category and are given the option of renting or purchasing movies and books through the website.

This site is not limited in focus to one particular subject matter or interest. Rather, the site carries a full library of hundreds or thousands of interrelated categories, arranged in a hierarchical structure. The site is limited only by the content of the story material that exists. The website is targeted specifically at the tens of thousands of niche interest groups/organizations/associations worldwide as well as the millions of people who have niche market interests and who prefer not to join associations and pay dues. Also, any single person may have interests in more that one subject matter category. Collectively, these consumers make up a massive market, encompassing hundreds of millions of category users.

For example, an amputee association may search for movies with subject matter relating to amputation or amputees, a mathematics association may search for movies and/or books relating to cryptology, etc. However, most individuals, including consumers, businessmen, hobbyists, medical professionals, etc., have a passion about certain subject matter areas and would find this website useful.

In addition to providing a way to find movies or books with certain subject matter content of interest, in one embodiment the site also allows the movies, books, or other stories listed on the site to be loaned, purchased, or rented using DVD, Blue-Ray, book or electronic download formats. The site thus acts as an efficient niche marketing, or narrowcasting, website, providing story products and other specialized items to groups and individuals with a very specific interest. By linking the IP number or email address of users' computers to the list of subject matter categories, a powerful tool is created for making future sales, financing and initiating new projects, and for coordinating focus group activities. In one embodiment, products are sold through an affiliate relationship with a large retailer, such as Amazon.com. In one such embodiment the site has a prepared shopping list of titles, books and movies that can be used to place orders.

Other items related to the movies, books, and other stories or to the subject matter they contain are also sold through the website. For example, many people are interested in the stories and scripts behind movies. In one embodiment, these items, which are often difficult to find, are for sale on the website and an inventory of them is maintained and used to fulfill orders through a fulfillment center. Further, the website receives the distribution rights from video and book publishers and then functions as a electronic download sub-distributor of the material. That is, the site streams the videos for movies and downloads the text for books in a similar manner to I-Tunes, Hulu.com, and Kindle.

Since this website attracts individuals with passion for a certain subject, in one embodiment such individuals are attracted to the site and encouraged to continue to return to and use the site by providing lots of additional subject matter information. In some such embodiments, dynamic sources of new content and information about different subjects are utilized, such as bloggers on the site discussing different topics, for example, “Science and the bible.” In this embodiment, people with certain subject matter interests are drawn to the site with information for each topic, bloggers, sorted media, etc., and encouraged to create an online community.

This website draws together people sharing a common interest and encourages them to form virtual associations. These associations of people with shared interests come together and have a desire to invest in certain projects promoting their interests. In one embodiment of the present invention, a website takes advantage of the virtual associations formed to market to associations and draw on them as a source of funding for the creation of new stories of interest to the associations. A set of templates on the site perform creation, development, financing, and distribution functions for books and other media, information, or materials for independent producers, filmmakers, etc.

In one embodiment, bringing either a book or movie product to the market follows a multi-step process with a series of website-contained information templates controlling each phase. The website is the focal point in establishing communications between the different participants, and the management of Storyworkz orchestrates and is responsible for making the effort a successful business activity. Not every product activity would go through every step.

The foundation to the commercial success of these products is inspired by the loyalty and passion that visitors have to the website information for those categories that interest them. Accordingly, website features are developed to solicit visitors for their knowledge, feedback and support in creating realistic and interesting story ideas, as well as for gaining their financial support for developing and distributing these products. And, most importantly, they provide a hard core set of people who buy these products and begin the process of jump starting a viral sales program.

In this embodiment, the associations are asked what kind of stories they are interested in, what kind of documentaries, books, etc. they want to see made. People interested in producing and distributing such works can then partner with Storyworkz or the association, or with both for bringing the product to market.

This methodology in one embodiment is a financing approach which is an alternative to the present Hollywood financing model which at present relies mainly on studio funding or acquiring production money from angel investors. The alternative financing approach that evolves from building an affinity group network from the system outlined in this patent application is very similar to operating a standard donor appeal program that associations have used with great success for years.

When the association has an issue it wants to address, it sends donor appeal material to its members, saying what it needs money for and requesting donations and thereby raising a large amount of funds to address the issue. The association may want to lobby congress, for example, to affect pending legislation. This same financing in one embodiment is applied to movie production. The association informs members of the subject matter of the movie or book and asks its members for funds to complete the project.

Designing the website to draw together people sharing common interests and providing them with relevant information to encourage the formation of virtual associations and the gathering and connection of association members through the site makes this model practical. People who have a passion for movies or movies covering a certain topic provide the drive and knowledge to fund the production and creation of new products.

### Detailed Example:

In one embodiment, the invention is implemented using a dynamic custom website that uses PHP for the coded language and MySQL for the database. Users are able to search through a list of movies and/or books for popular title(s). Users can also search for titles by using a category tree of links Users can view the details about the movie/book including year released, actors, story synopsis and movie type. Users are then able to rank these movies/book within their listed categories. Users are able to leave comments about the movies that will be posted after review. The system uses an algorithm based on user rankings to rank a title(s) within a given category.

In this example, every title comprises up to 5 niche categories and the user is able to make a one-time whole number entry into these category templates between 1 and 10, with 10 being the best and highest score and 1 the lowest and worst score. These numbers are entered into the database stored in the memory of the server. These ranking numbers are arithmetically averaged with rankings compiled from other IP users to give a composite number between 1 and 10, carried out two decimal places. Accordingly, the category rankings are in one embodiment re-aligned instantly and available on-line, to reflect the latest voting results, while all other data items describing the work (title, author, etc) remain the same. The rating number that is placed next to the title now, for example 1, 2, 2.5, 3, 3.5, 4 will not change. This 1-4 number represents a guide to the overall entertainment value of the film outside of any given subject matter category. It is very easy to visualize a film that has a 2 overall entertainment ranking and still achieves a 10 rating in the Chemistry subject matter category.

Each title has a corresponding data structure entry in the database stored in the physical memory of one or more servers. Each data structure has a number of attribute fields for use and display on the site, such as title, year of release, star actors, and rankings in each of various subject matter categories. Additional fields can be added to the data structures by user actions, for example when a user ranks a movie in a new subject matter category.

The exemplary embodiments disclosed herein focus on use of the disclosed systems and methods with movies and books, however the invention is not limited to these applications. Applicable, categorizable entertainment also includes at least TV shows and music, and other audio works such as works of comedy, as well as stage plays and notable works of art (paintings, sculptures, etc.), particularly those for which prints may be available, software, video games, and any other type of media. The same concepts described above in the context of movies and books are applicable to these other types of entertainment and easily adapted to such applications.

The invention is not limited to the particular embodiments illustrated in the drawings and described above in detail. Those skilled in the art will recognize that other arrangements could be devised, for example, with stories other than movies or books, or a differently configured or arranged website, or the use of downloadable software instead of or in addition to a website. The invention encompasses every possible combination of the various features of each embodiment disclosed. While the invention has been described with reference to specific illustrative embodiments, modifications and variations of the invention may be constructed without departing from the scope of the invention.

I claim:

1. A processor-based system, comprising:
a database configured to electronically maintain ranking data pertaining to one or more media works, said ranking data comprising:
one or more subject matter categories associated with each of the media works, and
a ranking associated with each subject matter category of each media work,
wherein each media work has a relative ranking compared to all other media works associated with the same subject matter category;
a ranking software module configured to electronically enable a user to rank the media works within the subject matter categories,
wherein based on the user rank of the media work the processor modifies the ranking of the media work associated with the subject matter category, said modified ranking of the media work being based both on the user rank of the media work and a previously assigned ranking of the media work,
a communications software module configured to electronically receive the user rank of the media works for the subject matter categories, and
a display and navigation software module configured to electronically transmit information stored in the database for display on a user interface and to allow the user to navigate through the displayed information.

2. The system of claim 1, further comprising a category addition software module configured to electronically enable a user to add a subject matter category associated with one or more of the media works or with one or more new media works.

3. The system of claim 2, wherein the category addition software module enables the user to perform at least one of:
selecting from an existing list of subject matter categories, and
inputting a new subject matter category.

4. The system of claim 1, further comprising a media work addition software module configured to electronically enable a user to add ranking data pertaining to a new media work to the database.

5. The system of claim 1, further comprising a search software module configured to electronically enable a user to search the database by ranking data.

6. The system of claim 1, wherein the display and navigation software module is configured to electronically transmit information stored in the database for display on a user interface organized at least by media work title and by subject matter category.

7. The system of claim 6, wherein the display and navigation software module is further configured to electronically transmit information stored in the database for display on a user interface organized by ranking within a subject matter category.

8. The system of claim 1, further comprising a store software module configured to electronically sell, rent, or lend media works to the user.

9. The system of claim 8, wherein the store software module is further configured to electronically sell, rent, or lend items related to the media works or to the subject matter category a media work is associated with to the user.

10. The system of claim 6, wherein the display and navigation software module is further configured to electronically transmit for display additional subject matter information, including links to websites with further subject matter information.

11. The system of claim 10, wherein the additional subject matter information includes dynamic information sources.

12. The system of claim 1, further comprising a comment software module configured to electronically enable a user to add a comment associated with one of the media works to the database.

13. The system of claim 1, further comprising a tracking software module configured to electronically track the user by IP address or login information and associate the user's rankings or other input with the user, wherein the other input comprises ratings, address, language, comments, category requests, product orders, survey responses, website navigation patterns or other user parameters.

14. The system of claim 13, wherein the tracking software module is further configured to use the user's associated rankings and other input for marketing purposes or for display in a community section of a website, whereby user profiles are developed for implementing new and expanded marketing, sales, product or business initiatives.

15. The system of claim 1, further comprising a community forum software module configured to provide a website interface through which enables users to interact and post messages to the community and to one another.

16. The system of claim 1, further comprising a community project software module configured to electronically provide a website interface enabling the user to advance a media project idea to or solicit a media project idea from other users associated with a subject matter category, receive input from the other users, and request funding for the project idea.

17. The system of claim 1, further comprising a media project software module that performs creation, development, financing, or distribution functions for media works and provides information and materials therefore.

18. A system, comprising:
a server-hosted database system that constructs, maintains, and rank orders a database of stories,
wherein each story is assigned a plurality of attributes that relate to subject matter categories,
a server-hosted website through which users access the database over the Internet to categorize the stories, add new stories, and rate the stories by category,
wherein the website receives user search input over the Internet and displays the stories to users by category and by rank within the category and rents or sells the stories to users.

19. A method, comprising:
providing on a processor-based system a database of media works,
assigning via the processor a set of multiple attributes to each media work relating to subject matter categories, wherein for each media work each respective subject matter category has a respective ranking,
displaying via the processor the media works to users by category and by ranking within the category,
receiving via the processor user input pertaining to at least one of media works, categories and rankings, and
categorizing via the processor the media works, adding via the processor new media works, and ranking via the processor the media works by category according to received user input.

20. The method of claim 19, wherein the displaying the media works comprises displaying them on a website and the receiving user input comprises receiving user input via the website.

21. The method of claim 20, further comprising providing additional information related to subject matter categories, tracking the user input of individual users via the processor, providing a website communication module through which users communicate with one another, categorizing the users via the processor according to subject matter categories and identifying users to other users according to their categorization, and providing a website module through which users categorized according to a certain subject matter category are contacted.

22. The method of claim 21, further comprising providing access to the categorized users to media project developers, distributors, studios, writers, producers or publishers.

23. The method of claim 20, further comprising selling or renting the media works to users over the website.

24. The system of claim 2, wherein one or more subject matter categories are subsets of another subject matter category and users add new subject matter categories within other subject matter categories.

25. A system, comprising:
a database system implemented on a processor-based system and configured for the construction, maintenance, and rank ordering of a database of a plurality of media works, wherein:
each media work of the plurality of media works is assigned one or more subject matter category attributes, and
each attribute can be assigned respective rank orderings for each respective media work of the plurality,
a communications module implemented on the processor-based system and configured to receive, from a user interface through which users access the database, at least one of a user-designated subject matter category, a user-designated media work, and a user-designated ranking for a particular media work within a particular subject matter category.

26. The system of claim 25, further comprising:
an informational display and sales module, implemented on the processor-based system, and configured to:
electronically receive user search input from the user interface,
electronically transmit to the user interface for display data pertaining to a media work, said data including a ranking of the media work within a subject matter category, and electronically rent or sell the media work to the user

27. A method, comprising:
entering via a processor-based system search input through a user interface configured to search for one or more media works associated with subject matter categories,
receiving via the processor-based system, based on the search, a display of rankings of one or more of the media works within a subject matter category,
inputting user rankings in the user interface and submitting them electronically, and
receiving via the processor-based system displayed rankings updated with the submitted user rankings.

28. The method of claim 27, further comprising submitting via the processor-based system an order to purchase, rent, or borrow one or more of the media works through the user interface.

29. The method of claim 27, further comprising submitting via the processor-based system an order to purchase, rent, or borrow material related to one or more of the media works through the user interface.

30. The method of claim 27, further comprising inputting via the processor-based system a new subject matter category into the user interface and submitting it electronically.

31. The method of claim 27, further comprising inputting via the processor-based system information about a new media work into the user interface and submitting it electronically.

32. The method of claim 27, further comprising entering via the processor-based system a comment about a media work into a comment field of the user interface and submitting it electronically.

33. The method of claim 27, further comprising selecting via the processor-based system a subject matter on the user interface and displaying sources of information about a subject matter category.

34. The method of claim 27, further comprising logging in via the processor-based system through a user interface login page, and performing at least one of displaying, reviewing and modifying past rankings and related information on a user tracking page of the user interface.

35. The method of claim 34, further comprising inputting via the processor-based system text intended for other users of a community forum of the user interface, and submitting the text electronically.

36. The method of claim 35, further comprising displaying information about past rankings along with the text, and inputting via the processor-based system information associated with a user and a subject matter category into the user interface and submitting it electronically for display along with the text.

37. In a processor-based system having a graphical user interface (GUI) including a display and an input device, a method of obtaining information on the display and modifying said information, the method comprising:
entering via the input device a new ranking of the media work in the subject matter category, and
receiving from a server coupled to the GUI an updated ranking of the media work in the subject matter category, wherein said updated ranking comprises a ranking based at least in part on the existing ranking and the new ranking

38. The method of claim 37, further comprising obtaining via the display information pertaining to an existing ranking of a media work in a subject matter category.

39. The system of claim 1, wherein the ranking data further comprises a general entertainment rating associated with each media work, wherein based on the ranking of the media work associated with a subject matter category, the general entertainment rating is modified when transmitted for display to a user associated with a subject matter category.

40. The system of claim 1, wherein the processor modifies the ranking of the media work associated with the subject matter category based on the user rank of the media work and other information about the user related to the subject matter category.
